(19) United States
(12) Patent Application Publication
(10) Pub. No.: US 2018/0025341 A1
(43) Pub. Date: Jan. 25, 2018

(54) Dynamic Payment Mechanism Recommendation Generator

(71) Applicant: International Business Machines Corporation, Armonk, NY (US)

(72) Inventors: Anca A. Chandra, Los Gatos, CA (US); Pawan R. Chowdhary, San Jose, CA (US); Susanne M. Glissmann-Hochstein, San Jose, CA (US); Thomas D. Griffin, Campbell, CA (US); Divyesh Jadav, San Jose, CA (US); Sunhwan Lee, Menlo Park, CA (US); Guangjie Ren, Belmont, CA (US); Hovey Raymond Strong, JR., San Jose, CA (US)

(73) Assignee: International Business Machines Corporation, Armonk, NY (US)

(21) Appl. No.: 15/218,344

(22) Filed: Jul. 25, 2016

(51) Int. Cl. G06Q 20/22; G06F 17/30

(52) U.S. Cl. CPC G06Q 20/227; G06F 17/3097

(57) ABSTRACT

Embodiments of the invention relate to a system, computer program product, and method for generating a recommendation for using a payment instrument or combination of payment instruments to tender payment. Payment instrument data is stored in a database. Upon receiving a request for a payment recommendation, payment instrument data is retrieved from the database and a payment instrument score is assessed across two or more payment instruments. The assessment comprises the application of a function to a payment instrument, the function taking into account payment instrument variables, category, and location. A recommendation of an apportionment of the payment is generated, including an allocation of an associated cost and the recommended payment is transmitted to a network server. The payment may then be tendered in accordance with the recommendation and recorded, or alternatively, the recommendation may be overridden and the payment tendered with the overriding data, the data then being recorded and the function adjusted accordingly.

### BACKGROUND

The present embodiments relate to an electronic payment system. More specifically, the embodiments relate to payment systems and recommendation of one or more payment mechanisms for associated expenses.

The proliferation of smart mobile devices together with the growth of online commerce has incubated the necessity of online shopping tools that are designed for the use of smart mobile devices. Common online shopping tools offer the user the convenience of saving his or her credit or debit card information for the purposes of enabling the card for purchases. In some cases, the information of multiple cards may be saved and selected for future use. In the case where the information for multiple cards is saved, the user is able to manually select one or more of the saved cards for making an online purchase using their smart mobile device.

Another feature of such online shopping tools is the function of allowing the user to choose a “default” card so that the online shopping tool automatically selects the default card when making an online purchase. If the user wishes an alternative card to be used, the user must override the automatic use of the default card by selecting an alternative card or inputting the information of an alternative card to be used.

### SUMMARY

These and other features and advantages will become apparent from the following detailed description of the presently preferred embodiment(s), taken in conjunction with the accompanying drawings.

In one aspect of the invention, a system is provided with a processor in communication with memory and data storage. One or more payment instruments are saved in an associated data structure, and organized based on their characteristics. The processor recommends an apportionment of expenses across one or more of these payment instruments. More specifically, upon receiving a request for a payment recommendation, it is determined whether a network connection is available, and upon finding a network, updating user location data. Purchases may be classified based on a plurality of parameters, and to accommodate the payment category, it is determined whether the immediate purchase falls into one of the categories. For example, in one embodiment, the categories may be defined as personal and business expenditures, although these categories should not be considered limiting and may include additional categories and/or subcategories. A function, which takes into account payment instrument variables and categories, is applied to a payment instrument. One or more payment instruments is/are selected in accordance with the functions and an expense apportionment and payment tendering action is conducted with the selected payment instruments.

In another aspect of the invention, a computer program product for recommending an apportionment of payment across one or more payment instruments is provided. The computer program product comprises a computer readable storage device having program code embodied therewith and the program code is executable by a processor. The code is executable by the processor to save one or more payment instruments onto a database, receive a request for payment recommendation, and determine if a network connection is available. Upon finding a network, the processor updates user location data, determines the purchase category of the payment, and applies a function to a payment instrument wherein the function takes payment instrument variables and category into account. One or more payment instruments is/are selected in accordance with the functions and an expense apportionment and payment tendering action is subsequently conducted with the selected payment instruments.

In yet another aspect of the invention, a method is provided for generating a recommendation for using a payment instrument or combination of payment instruments to tender payment. Upon receiving a request for a payment recommendation, payment instrument data is retrieved from a database and a payment instrument score is assessed across two or more payment instruments. The assessment comprises the application of a function to a payment instrument, the function taking into account payment instrument variables, category, and location. An expense apportionment and payment tendering action is then conducted whereby one or more payment instruments are selected in accordance with the function, payment is transmitted to a network server in accordance with the recommended apportionment, the function is adjusted to an updated function and transmitted to the network server, and payment data is recorded.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments unless otherwise explicitly indicated.

FIG. 1 depicts a block diagram illustrating a system diagram of a physical architecture in support of payment apportioning.

FIG. 2 depicts a flow chart illustrating a process for flow of logic associated with the payment analysis and the associated tools.

FIG. 3 depicts a flow chart illustrating a process for analysis and payment instrument recommendation.

FIG. 4 depicts a flow chart illustrating a process for configuring a template.

FIG. 5 depicts a schematic example of a system to implement the process of FIGS. 2-4 and the system of FIG. 1

FIG. 6 depicts a block diagram illustrative of a cloud computing environment.

FIG. 7 depicts a block diagram illustrating a set of functional abstraction model layers provided by the cloud computing environment.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

A credit card is a card issued by a financial company giving the holder an option to borrow funds, usually at a point of sale. Credit cards charge interest and are primarily used for short-term finance. Card holders draw on a credit limit approved by the card-issuer. Similar to the credit card, a debit card is a payment card used to make an electronic withdrawal of funds on deposit at a bank, as in purchasing goods or obtaining cash advances. Use of the debit card results in funds being directly withdrawn from a consumer's bank account, such as a savings or checking account, to pay for a purchase. Accordingly, the credit card and the debit card are instruments issued by a financial company or bank to facilitate commercial transactions.

Incentive programs, also known as loyalty program, have been created by the financial companies and banks that issue credit and debit cards. These incentive programs are a scheme used to promote or encourage use of the card. A loyalty program may give a consumer advanced access to new products, special sales coupons or free merchandise. One form of an incentive is where a percentage of the amount spent on the card is paid back to the card holder, also referred to herein as cashback or cash back reward. In one embodiment, the incentive may be a reward of point or air miles. Rewards may be dynamic or static, with the dynamic reward changing over time and having a start date and an end date. Accordingly, the goal of the loyalty program is to encourage the consumer to use their account associated with the issued card to one or more transactions.

A profile is created based on registered cards, including credit card, debit card, and other banking instruments, preferences, and rules. Incentives and obligations associated with the registered cards are monitored so that suggested may be dynamically issued for application of expenses across one or more of the cards. In one embodiment, behavior associated with the holder of the card(s) is tracked and employed in the dynamic application to a future expense allocation. The following table is an example of a minimum set of input data per card to be monitored:

TABLE 1

| Item | Required |
|---|---|
| Credit Card | Number, Issuer, Expiration Date, |
| | CVV |
| Personal/Business | Categorization of registered cards |

The following table is an example of a first optional set of input data, in addition to the data present in Table 1, per card to be monitored:

TABLE 2

| Item | Extended Option 1 |
|---|---|
| Credit Card | Statement Close Date |
| | Payment Due Date |
| | Hard limit of charges per billing |
| | period |
| Personal/Business | Location/Duration based card |
| | preference |

The following is an example of a second optional set of input data, in addition to the data presents in Table 1 and Table 2, per card to be monitored:

TABLE 3

| Item | Extended Option 2 |
|---|---|
| Credit Card | APR |
| | Current Balance |
| | Credit limit and percentage of |
| | credit limit to exercise per billing |
| | period |
| | Card email account credentials to |
| | mine rewards and incentives |
| Personal/Business | Location and duration preferences |
| | filtered by expense type |

Different payment instruments are known to have different incentives, rewards, obligations, and rules, each of which may be subject to change. For example, in one embodiment, an incentive program may be limited, and have an associated expiration. Based on the options outlined in Tables 1, 2, and 3, a payment recommendation is returned, with suggestions or one or more payment instruments. In one embodiment, an override of the payment recommendation is provided. Accordingly, one or more recommendations are provided, with each recommendation enabled by an override.

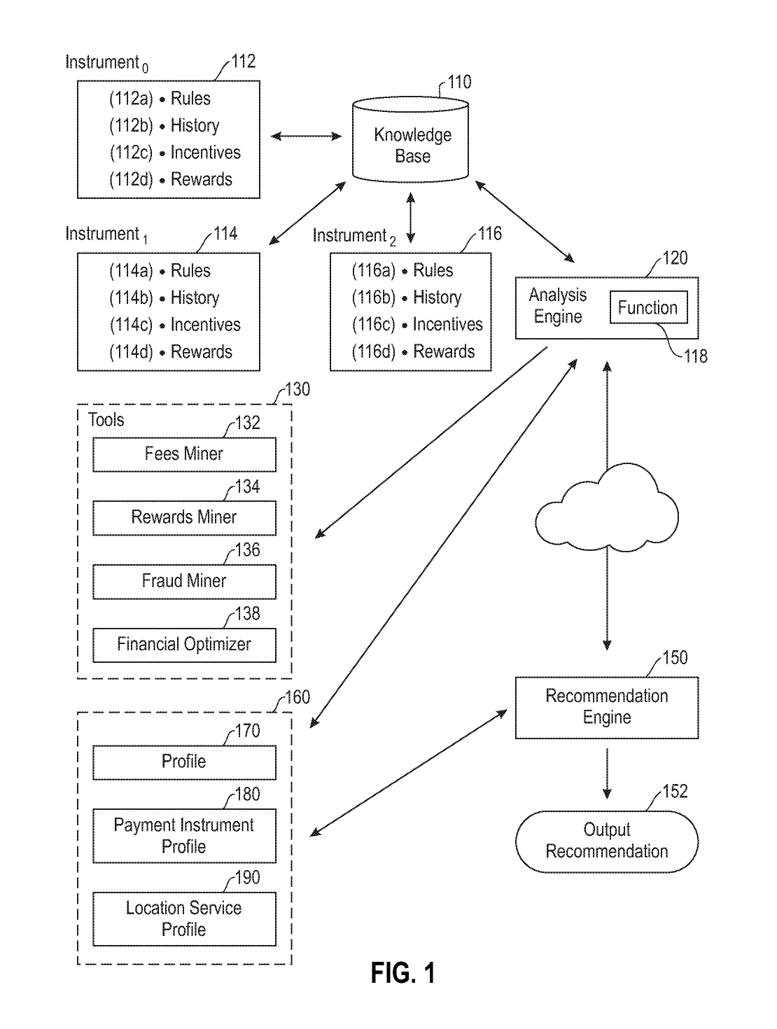

With reference to FIG. 1, a system diagram (100) of the payment apportioning is provided demonstrating a physical architecture of the system components. As shown, the components include a knowledge base (110) and two engines, including an analysis engine (120) and a recommendation engine (150). The knowledge base (110) functions as a storage component to retain aspects related to the payment instruments, including but not limited to rules, history, incentives, rewards, etc. One aspect of the knowledge base (110) is shown with the retained data organized on a payment instrument basis. For example, in one embodiment, a user is associated with three payment instruments, instrument₀ (112), instrument₁ (114), and instrument₂ (116), with data managed for each of the instruments. As shown, instrument₀ (112) has associated rules (112a), history (112b), incentives (112c), and rewards (112d); instrument₁ (114) has associated rules (114a), history (114b), incentives (114c), and rewards (114d); and instrument₂ (116) has associated rules (116a), history (116), incentives (116c), and rewards (116d). The history component of each instrument stores the actions associated with the instruments, including recommendations, payments in full, partial payments, over-rides, etc. In one embodiment, the instruments may store additional information or even a subset of the information shown herein. Accordingly, the knowledge base (110) functions to store data related to the payment instruments.

The analysis engine (120) functions in conjunction with the knowledge base (110) to provide insight and recommendations associated with the payment instruments. As shown herein, the analysis engine (120) employs a subset of tools (130), e.g. components, to facilitate analysis and recommendations. More specifically, the subset includes a fees miner (132), a rewards miner (134), a fraud miner (136), and a financial optimizer (138). In one embodiment, additional tools or a selection of tools in the subset may be employed, and as such, the subset shown herein should not be considered limiting. The fees miner (132) functions as a tool in communication with the analysis engine (120) to gather fees associated with the payment instruments being managed. For example, in one embodiment, a payment instrument may have an annual fee to keep the instrument in an active status. Similarly, in one embodiment, a payment instrument may have a fee associated with non-payment or partial payment of the account. The fees miner (132) communicates fees for each instrument being managed with the associated fee data maintained in the knowledge base (110), and in one embodiment, associated with the specific instrument. Accordingly, the fees miner (132) tracks fees associated with the payment instrument, and as the associated data is obtained, a copy is retained and associated with the instrument in the knowledge base (110).

Similar to the fees miner, the rewards miner (134) functions in conjunction with the analysis engine (120) to manage rewards associated with the payment instruments. As discussed above, different payment instruments may have different rewards to entice consumers to use their payment instruments for completion of a transaction. In one embodiment, the rewards may be in the form of points, cash back, frequent flyer miles, etc. As a transaction associated with the instrument is completed, the rewards are placed into the associated account. At the same time, the rewards may be dynamic and subject to change. The rewards miner (134) functions to track the active status of the reward and any associated closing date. For example, in one embodiment, the payment instrument may offer a greater percentage of cash back for a set period of time, and then the time expires, the reward expires. Characteristics of the associated rewards, including opening and closing data, and the reward amount, are tracked in the knowledge base (110) and associated with the payment instrument.

The fraud miner (136) functions similar to the rewards miner (134) in that it functions in conjunction with the analysis engine (120). However, the fraud miner (134) functions to manage fraud associated with a payment instrument. Hackers and associated elements are known to obtain or try to obtain access to the payment instruments, and when access is obtained fraudulent charges may appear on the payment instrument. The fraud miner (134) functions to address the fraudulent use of the payment instrument. In one embodiment, purchasing history is tracked to determine if a specific purchase is out of the ordinary and needs to be investigated. Similarly, in one embodiment, activity into use or continued use of the payment instrument may warrant investigation into the use. As such, the fraud miner (134) functions to track inappropriate use of the payment instrument. Characteristics associated with fraud are mined and populated into the knowledge base (110) and associated with the payment instrument.

The financial optimizer (138) functions in conjunction with the analysis engine (120) and stores associated financial data in the knowledge base (110). In one embodiment, a user may have multiple payment instruments, each with different opening and closing dates for payment on their associated accounts. At the same time, the user may have income received on a weekly basis, bi-weekly basis, or a monthly basis. Depending on the income frequency, the payment instruments may be optimized for financial management. Data associated with payment instruments, such as payment opening and closing data, and data associated with income frequency payment are stored and managed in the knowledge base, so that they may be leveraged for payment optimization.

As shown and described herein, the analysis engine (120) employs the tools of the miners (132)-(136) and the optimizer (138), and stores the collected data in the knowledge base (110). In one embodiment, the knowledge base (110) is a persistent storage component. Similarly, as shown herein, the knowledge base (110) is local to the analysis engine, although in another embodiment, the knowledge base (110) may be a remote storage device. Similarly, the analysis engine (120) may be a processor, microprocessor, or circuit, configured to communicate with the knowledge base (110) to support writing data to the knowledge base (110) and reading data from the knowledge base (110). Each of the miners (132)-(136) may be in the form of a processor, microprocessor, circuit, or alternative hardware device to support the functionality described above. Accordingly, the engine (120), the miners (132)-(136), and the optimizer (138) are configured as separate hardware devices that communicate to support management of payment instruments.

The tools shown and described herein pertain to collecting data from different sources and storing the data in persistent storage. The analysis engine (120) employs the collected data for the associated analysis, and communicates the analysis to a recommendation engine (150). More specifically, the recommendation engine (150) leverages data compiled and analyzed, and outputs a payment recommendation (152). For example, in one embodiment, the recommendation (152) may be for payment in full using one of the payment instruments, such as instrument₀ (112). Similarly, in one embodiment, the recommendation (152) may be for a payment in full in the form of a split between payment instruments, with partial payment utilizing instrument₀ (112) and instrument₁ (114). The recommendation engine (150) is a hardware device which may be in the form of a processor, microprocessor, or circuit. In one embodiment, the recommendation engine (150) communicates with the analysis engine (120) through a network connection.

The analysis engine (120) shown and described above functions to analyze payment transactions based on data, which is shown obtained from the miners (132)-(136), and the optimizer (138). In addition, and as shown, the analysis engine (120) receives input data (160). In one embodiment, the analysis engine (120) may receive input data (160) via the recommendation engine (150). Input is shown herein as various forms including a user profile (170), a payment instrument profile (180), and a location based service profile (190). As shown, the user profile (170) includes, but is not limited to, current security and authentication parameters, current payment instruments with balances, current objective function for recommendations based on current time, location, financial factor, and risk factors, current location, current request for implicit or explicit recommendation or current user action after recommendation, and history of requests, recommendations, and actions. The payment instrument profile (180) includes, but is not limited to, a credit cycle, if any, an interest rate, if any, current balance transfer parameters, and risk factors. The location based service profile (190) includes, but is not limited to, user fees, service limits, and risk factors. In addition, input data (160) may also be configured to include an event stream of profile updates, such as fraud events and parameter change events.

The output recommendation (152) is data associated with a reaction of payment analysis communicated from the recommendation engine (150). More specifically, output (152) is a response to a recommendation request that is initiated by the user, which in one embodiment may include an associated explanation. Similarly, in one embodiment, as described below, an objective function (118) is employed by the analysis engine (120) to adapt to the behavior of the user in conjunction with the payment instruments (112)-(116), and output (152) may be in the form of an update communication to the function (118). In one embodiment, the recommendation engine (150) may be embedded with a mobile communication device, such as a mobile telephone or a tablet computer. The user may initiate an action, also referred to herein as output (152), using a short-range wireless technology that enables communication between devices, such as near field communication (NFC), to solicit and execute an associated selection for a payment instrument. In one embodiment, NFC employs one or more interaction scripts to solicit and execute the selection, and the output (152) may be in the form of one or more of the script(s). Accordingly, output is response data that is associated with the payment instruments.

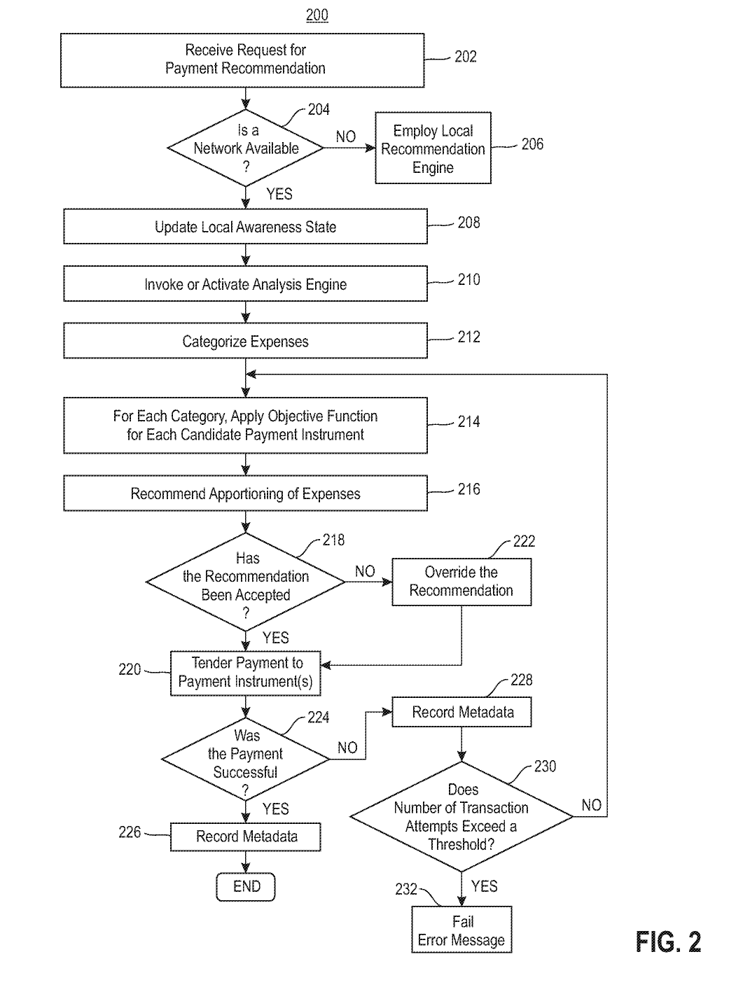

Referring to FIG. 2, a flow chart (200) is provided illustrating flow of logic associated with the payment analysis and the associated tools. As shown, a request for a payment recommendation is received (202). As described in FIG. 1, a plurality of payment instruments may be available, with each instrument having different characteristics and associated costs and benefits. In one embodiment, the payment recommendation analyzes the cost and benefit of each of the available instruments. Following step (202), it is determined if a network connection is available (204). In one embodiment, the request at step (202) is communicated to the analysis engine across a network connection. In the event that the network connection is not available, whether temporary or long term, a local recommendation engine may be employed (206). Similarly, in one embodiment, a message may be communication to the initiator of the payment recommendation that the network connection is not available, the initiator may select to wait until such time as the connection is available in the event of a preference of a remote recommendation engine. If at step (204) it is determined that the network connection is available, a location awareness state is updated (208). As described in FIG. 1, input to the analysis engine employs location based profile data, including but not limited to, current location. Following the update at step (208), the analysis engine is invoked or otherwise activated (210). Accordingly, the first part of the analysis solicits location data.

As shown in FIG. 2, two or more payment instruments may be available for allocation of expenses. It is understood that there may be a division of expenses based on categorization. For example, in one embodiment expenses may be categorized into personal expenses and business expenses. In one embodiment, there may be a further division of expenses, and as such, the division should not be limited to these two categories. A category is assigned to an associated expense (212). In one embodiment, the categorization is received as input to the analysis engine. Similarly, in another embodiment, the analysis engine assigns a category to the associated expense. For each expense category and each candidate payment instrument, the analysis engine applies an objective function (214), and a recommendation for apportioning of expenses is generated as output from the analysis engine (216). Accordingly, the function is utilized by the engine for analysis and payment recommendation. Unless the payment recommendation is overridden by the user, payment is tendered through the network server in accordance with the recommendation. Actions of recommending payment and tendering payment are collectively referred to as an expense apportionment and payment tendering action.

As shown and described, the recommendation may be communicated as output data from the recommendation engine. Following step (216), it is determined if the recommendation is accepted (218). In one embodiment, there is no requirement for the recommendation to be executed. A positive response to the determination at step (218) is following by tendering payment of expenses to the payment instruments apportioned in the manner set forth in the recommendation (220). However, a negative response to the determination at step (218) is followed by an override of the recommendation (222) and a return to step (220) for tendering payment based on the override instructions. In one embodiment, the override instructions include an alternate apportionment of expenses. Accordingly, the recommendation may be accepted, or in one embodiment, rejected and replaced by an alternate set of instructions. The process of generating a recommendation for an apportionment of payment, receiving acceptance or rejection, overriding data and/or tendering payment, is collectively referred to herein as an expense apportioning and payment tendering action. Accordingly, the expense apportioning and payment tendering action may be manifested in several embodiments, two of which include an acceptance of the recommendation and a rejection of the recommendation.

Following step (220), it is determined if the payment was successful (224). There is a plurality of reasons that the payment may be unsuccessful. For example, in one embodiment, the payment instrument employed in the transaction may have a credit limit, and the payment may exceed the limit. If at step (224) it is determined that the payment was successful, metadata associated with the payment is recorded (226), and the process concludes. More specifically, at step (226), data corresponding to the payment is recorded, and in one embodiment, the objective function is updated in accordance with the payment and transmitted to the network server. However, if at step (224), it is determined that the payment was not successful, the transaction metadata is recorded (228), and it is determined if the number of times the transaction has been initiated exceeds a threshold (230). A positive response to the determination at step (230) is followed by receipt of a fail error message (232) and indication that the transaction at step (220) did not execute. However, a negative response to the determination at step (230) is followed by a return (234) to step (214) for re-calculation and application of the underlying objective function so that a new apportionment recommendation may be solicited and employed for tendering payment to one or more of the associated payment instruments. Accordingly, the logic flow shown and described employs an objective function for apportionment of payment among one or more payment instruments.

As described in FIGS. 1 and 2, the analysis engine is employed to analyze the expense based upon available payment instruments and associated characteristics. More specifically, the analysis engine employs an objective function, which outputs a score to the recommendation engine. In one embodiment, the score is referred to as a Payment Instrument Score (PINS). Details of the PINS are described herein. The following is an example of the formula employed for the PINS:

(w1*ER)−(w2*EP)+(w3*ERA)+(w4*LA)+(w5*HS)+(w6*MF)

where wᵢ pertains to a weight, and in one embodiment has a value between 0 and 1, and each of the variables has a value between 0 and 1. The variable ER pertains to an estimated reward associated with one of the payment instruments. Examples of an estimated reward include, but are not limited to, a percentage of cash back, temporal rewards, and points. The variable EP pertains to an estimated penalty associated with one of the payment instruments. Examples of an estimated penalty include, but are not limited to, finance charges and fees. The variable ERA pertains to an estimated risk aversion associated with one of the payment instruments. Examples of the estimated risk aversion include, but are not limited to, location specific fraud patterns, which may be published or otherwise discovered. The variable LA pertains to location affinity associated with one of the payment instruments. Examples of the location affinity include, but are not limited to, previous usage in the same location, and location specific incentives. The variable HS pertains to historical similarity associated with one or more of the payment instruments. Examples of historical similarity include, but are not limited to, similar charges in one or more prior transactions, and overrides. The variable MF pertains to monetary flexibility associated with one or more of the payment instruments. Examples of monetary flexibility include, but are not limited to, constraints and billing cycle distance. It is understood that for a given transaction, some of the factors may be irrelevant, and as such may not play a role in the score.

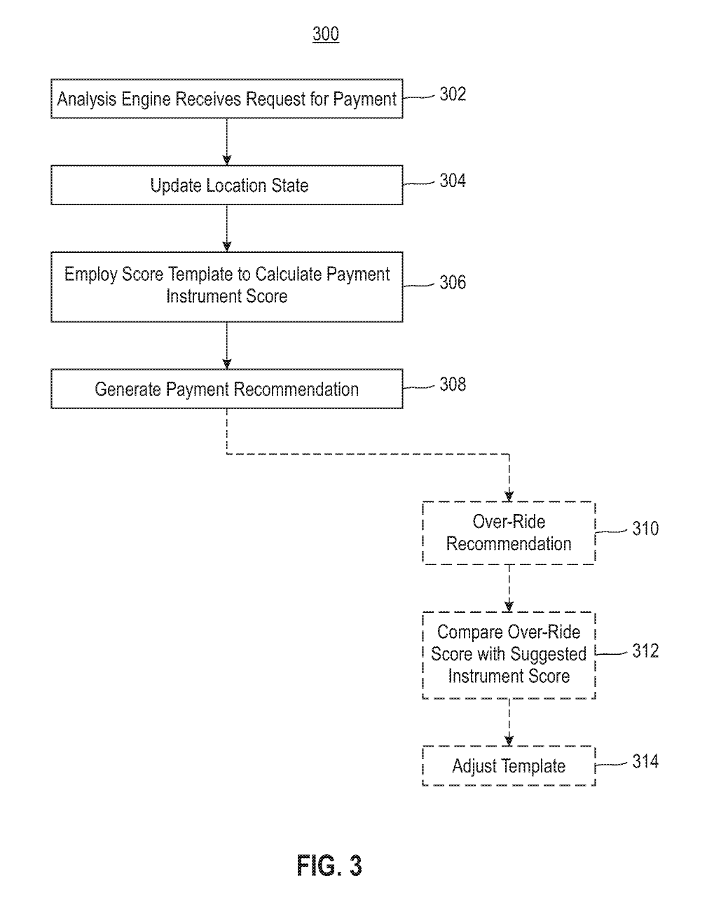

Referring to FIG. 3, a flow chart (300) is provided illustrating a process for analysis and payment instrument recommendation. As shown, a request for a payment recommendation is received by the analysis engine (302). Based on availability of a network connection and an updated location state (304), the analysis engine employs a score template that utilizes the PINS formula to calculate a score of one or more of the available payment instruments (306). The location state is ascertained via an IP address, GPS location, cellular data, and other location identification tools and addresses. In one embodiment, a PINS template is available for selection at step (306). Accordingly, the analysis recommendation employs a score assessment tool in the form of a score template.

There may be different forms of PINS templates depending on weighting of the available variables. For example, in one embodiment a template may have an equal division is allocated across each applicable component in the assessment. So, if there are four applicable components, then each component is assigned a weight of 0.25. In one embodiment, the equal division across components is applied during a first time use of the PINS. Similarly, in one embodiment, the equal division across components is referred to as a default application, unless a different formulation is provided or instructed. In one embodiment, a pre-configured PINS template may be selected. For example, one template may be configured to maximize available rewards, with the weight for the ER variable assigned a value of 0.50 and the remaining weights are divided among the remaining variable. So, if there are five variables remaining, each will be assigned a weight of 0.10, thereby effectively reducing the contribution of these remaining five variables. Another template may be configured to maximize cash flow, with the weights for the EP and MF variable each assigned a value of 0.35, and the remaining weights are divided among the remaining variable. So, if there are three remaining variables, each will be assigned a weight of 0.10. Accordingly, a score template may be selected from a library of one or more templates.

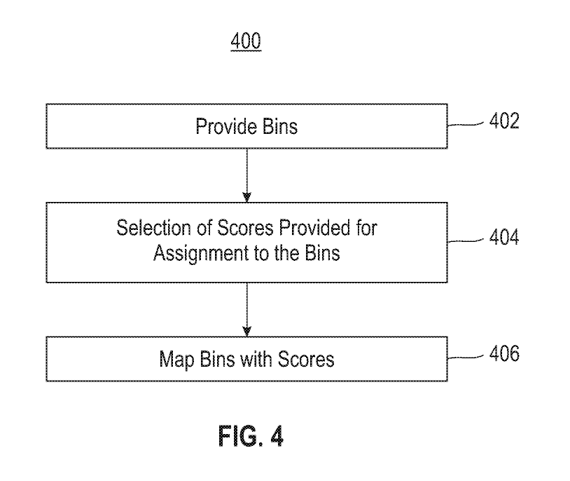

As shown at step (306), a template may be selected from a selection of available and configured templates. In one embodiment, a template may be configured or otherwise defined, as shown and described in FIG. 4. A payment recommendation is generated based on the output from the score template (308). Prior to transmission of an associated payment based on the recommendation, an override of the recommendation may take place (310). For example, the recommendation from the score template may suggest use of payment instrument₀ and the override may select use of payment instrument₀. When the override action takes place at step (310), a comparison of a score of the selected override instrument, e.g. instrument₁, with the score of the suggested instrument, e.g. instrument₀, takes place (312), and the selected template is adjusted (314). The adjustment may take on different forms. In one embodiment, the adjustment is manual, and in another embodiment the adjustment is automated, also referred to herein as self-correcting. Accordingly, as shown herein behavior as demonstrated by selection of a payment instrument in view of a recommended payment is managed to reflect instrument preference and selection.

As described in FIG. 3, a score template is provided or selected from a library of templates. Similarly, a score template may be configured based upon preference selection. Referring to FIG. 4, a flow chart (400) is provided illustrating a process for configuring a template. A plurality of bins is provided (402), with each bin reflecting a sub-component, and a selection of scores is provided for assignment to the bins (404). Each bin is mapped with a score (406). For example, a reward associated with a payment instrument may be in the form of cash back based on a percentage of purchases. Such rewards may be in the range of no reward, 0.5%, 1%, 2% or greater than 2%, with each designation assigned to a separate bin, and each bin weighted accordingly, e.g. 0, 0.25, 0.5, 0.75, and 1.0. Similarly, in one embodiment, a variable in the template may have a binary value, e.g. ERA, which is weighted accordingly. There are different forms of aggregating and transforming weight assignments to the variables. In one embodiment, scores are aggregated and normalized with the normalized score applied to the variable. In another embodiment, the maximum of a plurality of scores are applied to the variable. Accordingly, a template is configured based upon a plurality of scores and variables, with the assignment of weights to variables reflecting importance in the instrument selection process.

The system described above in FIG. 1 has been labeled with tools. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

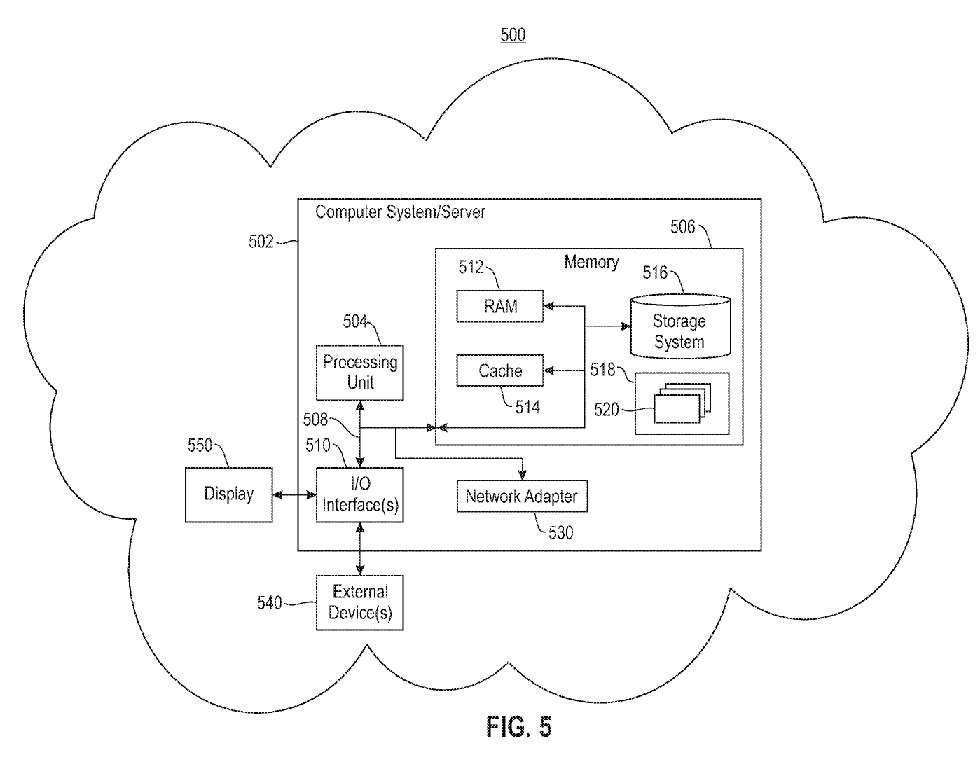

Aspects of the tools and their associated functionality may be embodied in a computer system/server in a single location, or in one embodiment, may be configured in a cloud based system sharing computing resources. With references to FIG. 5, a block diagram (500) is provided illustrating an example of a computer system/server (502), hereinafter referred to as a host (502) of a cloud based support system, to implement the processes described above with respect to FIGS. 2-4. Host (502) is operational with numerous other general purpose or special purpose computing system environments or configurations. Examples of well-known computing systems, environments, and/or configurations that may be suitable for use with host (502) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems or devices, and the like.

Host (502) may be described in the general context of computer system-executable instructions, such as program modules, being executed by a computer system. Generally, program modules may include routines, programs, objects, components, logic, data structures, and so on that perform particular tasks or implement particular abstract data types. Host (502) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, host (502) is shown in the form of a general-purpose computing device. The components of host (502) may include, but are not limited to, one or more processors or processing units (504), a system memory (506), and a bus (508) that couples various system components including system memory (506) to processor (504). Bus (508) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (502) typically includes a variety of computer system readable media. Such media may be any available media that is accessible by host (502) and it includes both volatile and non-volatile media, removable and non-removable media.

Memory (506) can include computer system readable media in the form of volatile memory, such as random access memory (RAM) (512) and/or cache memory (514). By way of example only, storage system (516) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (508) by one or more data media interfaces.

Program/utility (518), having a set (at least one) of program modules (520), may be stored in memory (506) by way of example, and not limitation, as well as an operating system, one or more application programs, other program modules, and program data. Each of the operating systems, one or more application programs, other program modules, and program data or some combination thereof, may include an implementation of a networking environment. Program modules (520) generally carry out the functions and/or methodologies of embodiments of dynamic apportioning of accounts as described herein. For example, the set of program modules (520) may include the modules configured to implement the dynamic analysis and apportioning processes described above with reference to FIGS. 2-4.

Host (502) may also communicate with one or more external devices (540), such as a keyboard, a pointing device, etc.; a display (550); one or more devices that enable a user to interact with host (502); and/or any devices (e.g., network card, modem, etc.) that enable host (502) to communicate with one or more other computing devices. Such communication can occur via Input/Output (I/O) interface(s) (510). Still yet, host (502) can communicate with one or more networks such as a local area network (LAN), a general wide area network (WAN), and/or a public network (e.g., the Internet) via network adapter (530). As depicted, network adapter (530) communicates with the other components of host (502) via bus (508). In one embodiment, a plurality of nodes of a distributed file system (560) is in communication with the host (502) via the I/O interface (510) or via the network adapter (530). It should be understood that although not shown, other hardware and/or software components could be used in conjunction with host (502). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (506), including RAM (512), cache (514), and storage system (516), such as a removable storage drive and a hard disk installed in a hard disk drive.

Computer programs (also called computer control logic) are stored in memory (506). Computer programs may also be received via a communication interface, such as network adapter (530). Such computer programs, when run, enable the computer system to perform the features of the present invention as discussed herein. In particular, the computer programs, when run, enable the processing unit (504) to perform the features of the computer system. Accordingly, such computer programs represent controllers of the computer system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

In one embodiment, host (502) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

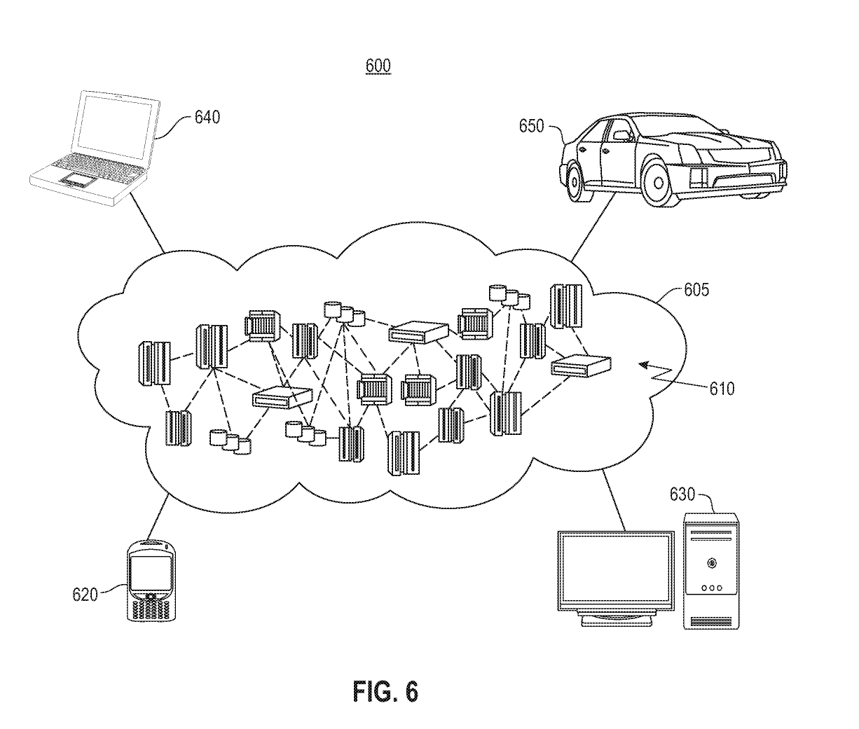

Referring now to FIG. 6, an illustrative cloud computing network (600). As shown, cloud computing network (600) includes a cloud computing environment (605) having one or more cloud computing nodes (610) with which local computing devices used by cloud consumers may communicate. Examples of these local computing devices include, but are not limited to, personal digital assistant (PDA) or cellular telephone (620), desktop computer (630), laptop computer (640), and/or automobile computer system (650). Individual nodes within nodes (610) may further communicate with one another. They may be grouped (not shown) physically or virtually, in one or more networks, such as Private, Community, Public, or Hybrid clouds as described hereinabove, or a combination thereof. This allows cloud computing environment (600) to offer infrastructure, platforms and/or software as services for which a cloud consumer does not need to maintain resources on a local computing device. It is understood that the types of computing devices (620)-(650) shown in FIG. 6 are intended to be illustrative only and that the cloud computing environment (605) can communicate with any type of computerized device over any type of network and/or network addressable connection (e.g., using a web browser).

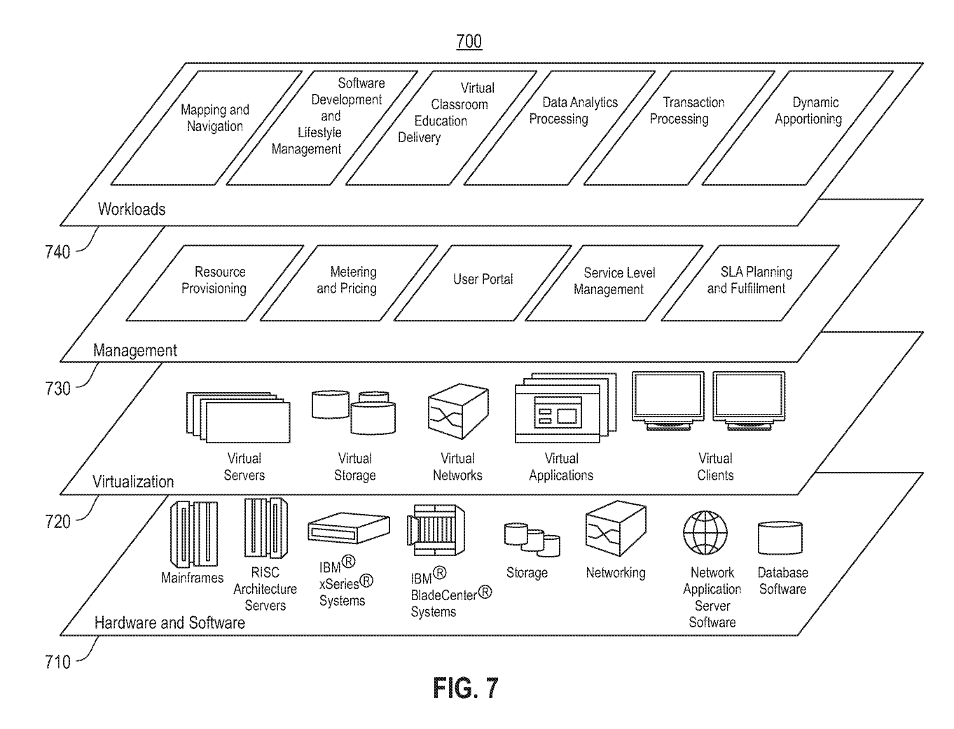

Referring now to FIG. 7, a set of functional abstraction layers provided by the cloud computing network of FIG. 5 is shown. It should be understood in advance that the components, layers, and functions shown in FIG. 7 are intended to be illustrative only, and the embodiments are not limited thereto. As depicted, the following layers and corresponding functions are provided: hardware and software layer (710), virtualization layer (720), management layer (730), and workload layer (740). The hardware and software layer (710) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (720) provides an abstraction layer from which the following examples of virtual entities may be provided: virtual servers; virtual storage; virtual networks, including virtual private networks; virtual applications and operating systems; and virtual clients.

In one example, management layer (730) may provide the following functions: resource provisioning, metering and pricing, user portal, service level management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (740) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and dynamic apportioning support within the cloud computing environment.

As will be appreciated by one skilled in the art, the aspects may be embodied as a system, method, or computer program product. Accordingly, the aspects may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the aspects described herein may take the form of a computer program product embodied in one or more computer readable medium(s) having computer readable program code embodied thereon.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for the embodiments described herein may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The embodiments are described above with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow chart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flow chart and/or block diagram block or blocks.

The flow charts and block diagrams in the Figures illustrate the architecture, functionality, and operation of possible implementations of systems, methods, and computer program products according to various embodiments. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustration(s), and combinations of blocks in the block diagrams and/or flow chart illustration(s), can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments described herein may be implemented in a system, a method, and/or a computer program product. The computer program product may include a computer readable storage medium (or media) having computer readable program instructions thereon for causing a processor to carry out the embodiments described herein.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmissions, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The embodiments are described herein with reference to flow chart illustrations and/or block diagrams of methods, apparatus (systems), and computer program products. It will be understood that each block of the flow chart illustrations and/or block diagrams, and combinations of blocks in the flow chart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow chart and/or block diagram block or blocks.

It will be appreciated that, although specific embodiments have been described herein for purposes of illustration, various modifications may be made without departing from the spirit and scope of the specific embodiments described herein. Accordingly, the scope of protection is limited only by the following claims and their equivalents.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Accordingly, the implementation of a payment instrument recommendation generator for recommending an allocation of purchase costs and tendering payment in accordance thereto may be achieved by a number of embodiments within the scope of the claims.

It will be appreciated that, although specific embodiments of the invention have been described herein for purposes of illustration, various modifications may be made without departing from the spirit and scope of the invention. Accordingly, the scope of protection of this invention is limited only by the following claims and their equivalents.

We claim:

1. A computer system comprising:
a processing unit operatively coupled to memory;
the processing unit to generate an apportionment of expenses across one or more payment instruments, comprising the processing unit to:
save one or more payment instruments onto a database;
receive a request for payment recommendation;
upon receiving a request, determine availability of a network connection;
determine a payment category for the payment recommendation;
apply a function to each payment instrument, wherein the function takes into account payment instrument variables within at least one payment category;
select one or more payment instruments in accordance with the functions; and
conduct an expense apportionment and payment tendering action with the selected payment instruments.

2. The computer system of claim 1, wherein the expense apportionment and payment tendering action comprises the processing unit to:
generate a recommended apportionment; and
tender payment in accordance with the recommended apportionment.

3. The computer system of claim 1, wherein the expense apportionment and payment tendering action comprises the processing unit to:
generate a recommendation of apportionment;
override the recommendation of apportionment;
record override input data; and
tender payment in accordance with override input data.

4. The computer system of claim 1, wherein upon determining that a network connection is not available, further comprising the processing unit to:
employ a local recommendation engine; and
notify an issuer of the request for payment recommendation of the unavailability of network connection.

5. The computer system of claim 1, wherein upon determining that a network connection is available, further comprising the processing unit to update user location data.

6. A computer program product for recommending an apportionment of payment expenses across one or more payment instruments, the computer program product comprising a computer readable storage device having program code embodied therewith, the program code executable by a processing unit to:
save one or more payment instruments onto a database;
receive a request for payment recommendation;
upon receiving a request, determine if a network connection is available;
determine a payment category of the payment recommendation;
apply a function to each payment instrument, wherein the function takes into account payment instrument variables and payment category;
select on or more payment instruments in accordance with the function; and
conduct an expense apportionment and payment tendering action with the selected payment instruments.

7. The computer program product of claim 6, wherein the expense apportionment and payment tendering action comprises the processing unit to:
generate a recommended apportionment; and
tender payment in accordance with the recommended apportionment.

8. The computer program product of claim 6, wherein the expense apportionment and payment tendering action comprises the processing unit to:
generate a recommendation of apportionment;
override the recommendation of apportionment;
record override input data; and
tender payment in accordance with override input data.

9. The computer program product of claim 6, wherein upon determining that a network connection is not available, further comprising the processing unit to:
employ a local recommendation engine; and
notify an issuer of the request for payment recommendation of the unavailability of network connection.

10. The computer program product of claim 6, wherein upon determining that a network connection is available, further comprising the processing unit to update user location data.

11. A method comprising:
receiving a request for payment recommendation, the request associated with an expense profile and an itemized financial transaction;
retrieving payment instrument data from a database;
assessing a payment instrument score across two or more payment instruments, the assessment comprising applying a function to a payment instrument, the function taking into account payment instrument variables, category, and location;
generating a recommended apportionment;
transmitting a payment in accordance with the recommended apportionment to a network server;
recording data of the payment;
adjusting the function to an updated function according to the payment; and
transmitting the updated function to the network server.

12. The method of claim 11, further comprising:
overriding the recommended apportionment;
recording overriding input data;
transmitting a payment in accordance with the overriding input data to a network server;
adjusting the function to an updated function according to the overriding input data; and
transmitting the updated function to the network server.

13. The method of claim 11, wherein one or more weights are applied to the function, and further comprising autonomously updating the weights in response to the updated function.

14. The method of claim 11, further comprising monitoring an event stream associated with a financial factor and a risk factor, and updating the function in response to the factors.
